(19) United States
(12) Patent Application Publication
(10) Pub. No.: US 2009/0277040 A1
(43) Pub. Date: Nov. 12, 2009

(54) METHOD AND DEVICE FOR DRYING AND FOR THE MATERIAL FLOW-SPECIFIC PROCESSING OF COARSE-GRAINED WASTE THAT CAN BE AERATED

(76) Inventor: Reinhard Schu, Walkenried (DE)

Correspondence Address: K.F. ROSS P.C., 5683 RIVERDALE AVENUE, SUITE 203 BOX 900, BRONX, NY, 10471-0900, US

(21) Appl. No.: 12/440,060

(22) PCT Filed: Jul. 14, 2007
(86) PCT No.: PCT/DE07/01264

§ 371 Date: Mar. 5, 2009

(30) Foreign Application Priority Data
Sep. 6, 2006 (DE) 10 2006 042 159.0

(51) Int. Cl. F26B 7/00; F26B 19/00; F26B 25/06

(52) U.S. Cl. 34/387; 34/60; 34/202

(57) ABSTRACT

The invention relates to a method and a device for drying and for the material flow-specific processing of coarse-grained waste that can be aerated. The invention is characterized by subjecting the waste in a first step to a hot air drying step (1) in a tunnel drier (10), followed by the subsequent process steps of sieving (2) to remove the fines, preferably with a grain size <40 mm, air separation (3), removal of metal (4) and optical sorting (5), and size reduction (6) of the residual fraction, preferably to a grain size <40 mm, and returning the size-reduced residual fraction to the tunnel drier (10).

Recovering useful materials and energy from waste and biomass is playing an increasingly more important part in waste economy and the overall energy supply. The utilization of waste, such as screen overflow from domestic waste, or industrial waste, packaging waste, biomass or wood chips, is demanded within the framework of a sustainable national economy.

Useful materials are obtained from waste, such as household garbage or industrial waste, by separating the constituents which they contain and which are utilizable in terms of material or energy. As a rule, several steps are necessary for this purpose. In a first step, separation may take place, for example, by selective comminution followed by grading into a coarse and a fine fraction. The coarse fraction having a high calorific value can then be utilized directly in energy terms, without further processing, in an alternative fuel utilization plant. If, however, direct efficient energy utilization is not possible, it is appropriate to carry out a further processing of the coarse fraction, with the aim of obtaining fractions utilizable in terms of material or energy.

This aim is also pursued by the present invention which relates to a method and a device for drying and for the material flow-specific processing of coarse-grained waste that can be aerated, that is to say of a material mixture having a low bulk density. The method may also be employed, for example, for the drying of biomass, such as wood chips.

It is known from the prior art, for the thorough processing of waste, first to subject this to drying. Drying improves the processing quality and the possibilities for the utilization of the subfractions to be separated. Furthermore, by means of drying, the calorific value of the dried stock can also be increased.

In the direct drying method for waste, a distinction is made between cold-air drying and hot-air drying.

In cold-air drying, the energy required for drying is extracted from the drying stock, for example via the cooling of the drying stock or via exothermal reactions in the drying stock. DE 196 49 901 A1 [U.S. Pat. No. 6,093,323] discloses, for example, the dry stability method as a cold-air drying method. Biological drying is to be achieved here by utilizing the intrinsic heating of the waste mixture in conjunction with forced aeration and energy recovery by means of heat exchangers. The energy for drying is generated mainly by the oxidation of organic constituents in the waste by means of microbacterial processes (composting). Disadvantages of this method are a high exhaust air volume flow of 4000-6000 m³/Mg and a high dwell time of 7-10 days for drying the waste. The long drying time and the consequently large reaction volume, moreover, require a high outlay in technical terms from the point of view of a complete encapsulation and automation of the plants. Similar methods are known from the laid-open publications DE 199 48 948 A1, DE 198 04 949 A1 and DE 197 34 319 A1.

Cold-air drying methods presuppose, as an energy source for drying, the presence of sufficient quantities of easily degradable organics. Easily degradable organics are contained to only a very small extent in the coarse fraction from domestic waste, and therefore the cold-air methods are unsuitable for this waste. In hot-air drying, the heat energy required for drying is delivered to the drying stock from outside predominantly by preheated air. In the waste economy, there are, for example, known methods using driers which are operated by natural gas as the primary energy carrier. In this case, high heating air temperatures are often achieved, so that, in the drying of heterogeneous waste, such as, for example, solvent-containing material mixtures, there may be the risk of fire. Moreover, as a rule, exhaust gas purification of the considerable smoke gases and of a part quantity of the exhaust air from the drier is required.

Hot-air drying often presupposes a comminution of the material to a grain size of less than 40 mm. This, however, is a disadvantage for subsequent fractionation with the aim of the utilization of high-quality material.

DE 199 37 454 A1 discloses a method in which a direct hot-air drying of domestic waste, that is to say without prior separation, is carried out in a continuous flow drier. For drying, the waste heat from an energy generation plant is to be utilized. On account of the absence of preceding separation, however, a sufficient full drying of the material cannot always be achieved, since the high proportion of a fine fraction, above all inert material (sand, stones) and moist organics, which, as a rule, is contained in domestic waste, leads to low porosity and therefore a low capability of the drying stock for aeration. Moreover, the organics contain considerable proportions of capillary and cellular water, thus making drying even more difficult.

Furthermore, DE 101 13 139 C1 discloses a device, by means of which a direct hot-air drying of previously comminuted domestic waste can be carried out in a double-shaft lamellar drier in circulating air operation. As in the abovementioned example, here too, too high a proportion of a fine fraction has an adverse effect. In addition, during drying by the circulating air method with high air rates, the blower has a markedly increased electric consumption on account of the lower porosity of the drying stock. For the abovementioned reasons, therefore, drying in such a drier is possible only when there are very long dwell times, in combination with small grain sizes and high drying temperatures.

For the hot-air drying of household garbage and/or that fraction of domestic waste which has a high calorific value, intensive driers with short dwell times and high drying temperatures are already being used today. Intensive driers require, before drying, a high degree of processing of the stock to be dried. Drum driers are known, which, as a rule, are heated by natural gas as pure fuel. The exhaust air is purified by means of scrubbers, fabric filters and regenerative thermal oxidation (RTC). For drum driers, the material has to be comminuted to a grain size 25<40 mm. Owing to the homogenization associated with this, however, subsequent separation of useful materials is still scarcely possible. Furthermore, on account of the high temperatures, there is an increased risk of fire, and there is also an adverse variation in the material properties of utilizable materials, for example utilizable plastics.

Proceeding from the known methods described above, the object of the present invention is to provide an improved method for drying and for the flow-specific processing of coarse-grained waste that can be aerated, and also a device for carrying out this method.

To achieve this object, the method as claimed in claim 1 and the device as claimed in claim 9 are proposed.

According to the invention, in the proposed method, in a first step, the waste is subjected to hot-air drying in a tunnel drier, whereupon this is followed by the further steps of screening for separating the fine stock, preferably with a grain size <40 mm, air separation, metal separation and optical sorting and also comminution of the residual fraction, preferably to a grain size <40 mm, and recirculation of the comminuted residual fraction into the tunnel drier. The advantages of this method are essentially an improvement in the separation properties, for example during screening or air separation, and the achievement of a storage stability of the separated useful materials by dry stabilization. Furthermore, mention may be made, as advantageous secondary effects, of an increase in the calorific value during energy utilization and of the setting of a residual moisture content of about 8 to 12% which is beneficial for subsequent pelletization.

Preferably, the hot-air drying takes place essentially in circulating air operation, the supply air, that is to say the circulating air supplied to the drying process, being preheated to temperatures of about 85° Celsius. The utilization of low-temperature waste heat of below 100° Celsius results in a reduction in the drying costs which already today amount to about 50% of the energy costs. At the same time, the safety provisions with regard to the risk of fire and of explosion in the possible presence of solvents can be adhered to by the maximum surface temperatures being undershot (cf. Directive 1999/92/EC of 16 Dec. 1999). The circulating air used as drying air must, for reuse, be dehumidified and at the same time cooled. For exhaust air cooling, a two-step cooling system is preferably used, the first cooling step taking place via air cooling and the second step via hybrid cooling.

Preferably, the exhaust air, that is to say the circulating air discharged from the tunnel drier, in the first cooling step is wet-scrubbed in a spray condenser or a spray scrubber, cooling to 40 to 45° Celsius (cooling limit temperature) taking place, depending on the inlet temperature. In this case, the dust and harmful and malodorous substances, for example ammonia and hydrogen sulphide, contained in the circulating air are washed out. The condensate/scrubbing water from the first step contains harmful substances and must be treated before being discharged into the drainage system, depending on sewage introduction conditions.

In the second cooling step, the circulating air enters the condenser which is designed as a hybrid cooling tower. Here, the circulating air is cooled to preferably lower than 30 to 35° Celsius. The condensate which occurs has only a low pollution level and, after sewage purification, can be utilized as cooling water in the hybrid cooling tower.

The cooled and dehumidified circulating air is then heated again to a drying temperature of more than 80° Celsius, preferably waste heat at a temperature level of about 90 to 100° Celsius being used. Should sufficient waste air be unavailable, the use of a heat pump is optionally possible. According to a preferred embodiment, at least part of the energy for heating and/or cooling the circulating air is provided, using a heat pump. By the circulating air being purified, drying may also be carried out, largely free of exhaust air, with the result that the exhaust air emissions are reduced considerably, as compared with other drying techniques. Only exactly as much exhaust air occurs as has to be sucked away from the system for reasons of leakage. Moreover, the drying and also the filling and/or emptying of the tunnel drier can be carried out fully automatically, and therefore, in addition, the emission of dust and bacteria for the plant personnel and the surroundings is minimized.

Preferably, the filling of the tunnel drier takes place via a shaft by means of traveling and reversible distribution conveyor belts. In the supply via the shaft supply system, the drying stock at the same time ensures sealing with respect to the supply system. For discharge, the tunnel drier preferably has, in addition to a draw-off system which may be implemented by a conveyor belt or scraper conveyor system, a rotary lock which is additionally provided with a winch system for the metered discharge from the tunnel and which at the same time forms an air shut-off with respect to the outlet system. Thus, the ingress of infiltrated air is minimized and, correspondingly, the exhaust air quantity is largely reduced. Furthermore, the use of metering devices for metering the material discharge allows effective and largely fault-free operation of the further processing assemblies.

Preferably, an oscillating floor system is used for conveying the drying stock through the tunnel drier, which allows a mass flow of the drying stock carried through the system. The dumping height in the tunnel drier amounts to between 3 and 6 m, depending on density. A stripper arranged on the ceiling side may be used for setting the dumping height. Preferably, furthermore, the dwell time in the tunnel drier amounts to less than eight hours.

The proposed low-temperature drying is a precondition for a high-quality material utilization of the coarse fraction. A maximized material utilization rate is made possible by the further development of positive sorting by means of fully automated optical recognition systems.

The further method steps which follow the drying involve comprehensive processing which commences with screening at 30 mm to 60 mm, preferably at 40 mm. This serves for separating the fine stock, since the latter would impair the cleanliness of the fly fraction. The fine stock is dry-stabilized and suitable for energy utilization. Optionally, the fine grain with a size of between 2 and 8 mm, preferably of 5 mm, may be separated from the screened-off fine fraction, for example, by means of a star screen, since this fine grain is an appreciable carrier of harmful substances in terms of heavy metals and salts.

By means of the air separation which follows screening, above all, sheet-like constituents, such as films, paper, paperboard, cardboard boxes and textiles, are separated. The fly fraction is dry-stabilized and can be utilized in energy terms or, after further processing, in material terms. A further advantage of the preceding drying is that air separation operates with a markedly higher separation resolution in the case of dry waste than in the case of wet waste. Air separation preferably takes place in two steps.

In a further step, Fe and NE metals are separated from the heavy stock from air separation via a metal separator. The dust-free and dry heavy fraction, which preferably has a grain size of between 40 and 300 mm, is then delivered for optical sorting (near infrared, X-ray). Here, all the optically detectable useful materials, such as PE, PP, PS, PET, PVC, wood, aluminum compounds and the like, are separated and are diverted as utilizable product fractions. The further processing of the product fractions takes place in a separate plant.

The remaining, undetected heavy fraction is comminuted, preferably to a grain size <40 mm, and is delivered again to the drying process, in order to allow a better drying of the coarse materials, wherein an enrichment of subfractions can be ruled out.

Preferably, the method described above is preceded by a pretreatment of the waste. The waste in an underground or low bunker is first comminuted coarsely to a target grain size of <150 mm to 350 mm and thereafter is separated by means of screening into a native-organic and inert-rich fraction <40 mm to 120 mm, preferably <60 mm to 80 mm, and into a plastic-rich oversized fraction having a high calorific value. Metal separation in the case of the oversized fraction is not necessary. The plastic-rich oversized or coarse fraction then passes first into the tunnel drier for carrying out drying.

The subject of the invention is also a device for carrying out a method described above. For this purpose, the device is equipped with a tunnel drier for hot-air drying and with a screening device, an air separator, a metal separator and an optical sorting device for processing the dried stock and also with a comminutor for the residual fraction to be returned to the tunnel drier.

Preferably, the tunnel drier possesses a two-step cooling system consisting of air cooling and of hybrid cooling for cooling the exhaust air, that is to say the circulating air discharged from the tunnel drier. Preferably, furthermore, the tunnel drier has an oscillating floor system for conveying the drying stock and a stripper, arranged on the ceiling side, for setting the dumping height, and also metering devices for a metered material discharge.

According to an advantageous design, the device additionally comprises a temperature detector, by means of which the introduction of glowing chips into the tunnel drier can be avoided.

The method and the device for carrying out the method are illustrated diagrammatically in the following drawings in which:

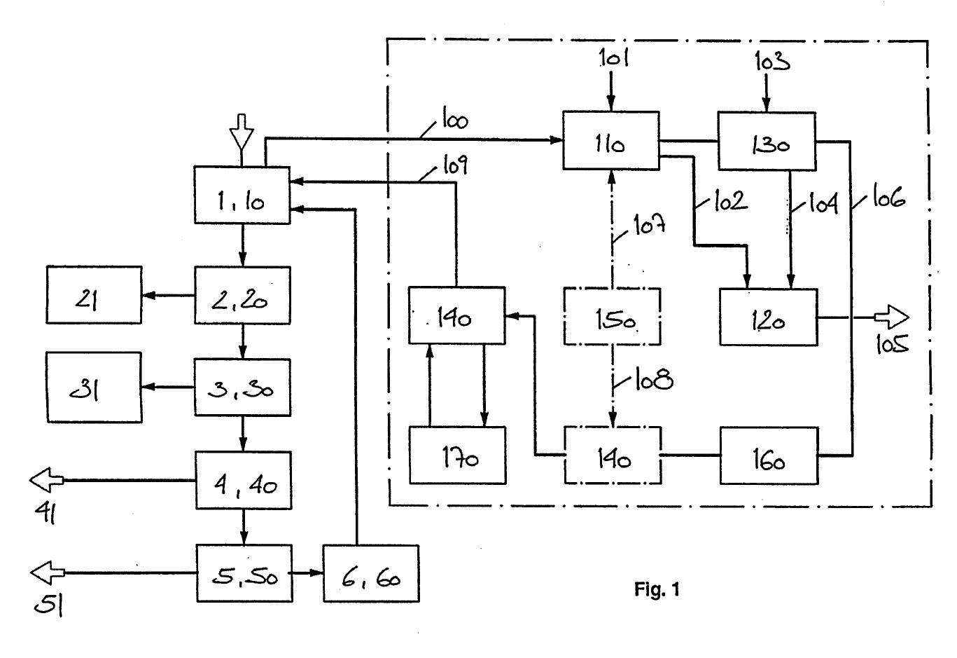

FIG. 1 shows the sequence of method steps and of the assigned device components

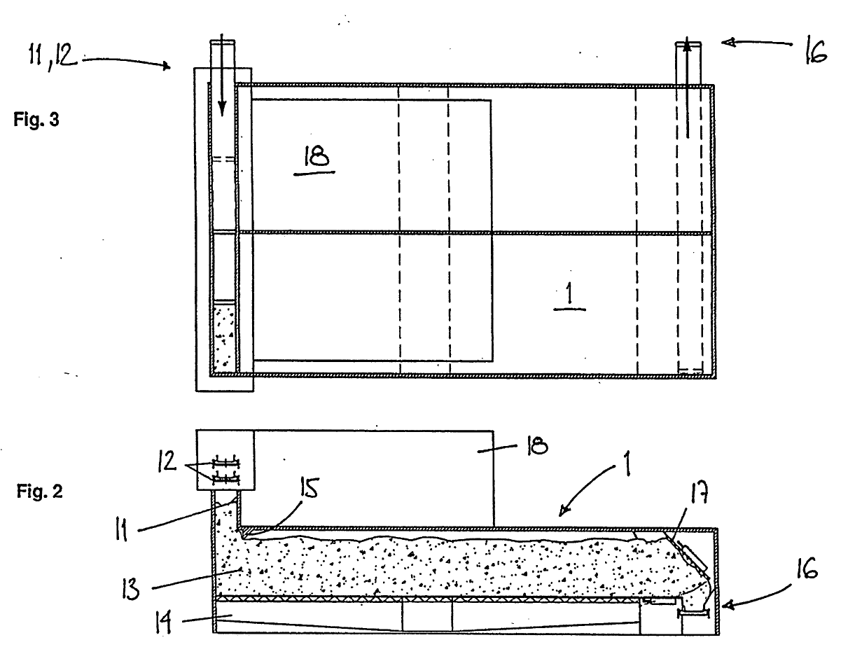

FIGS. 2 and 3 show sectional views of a tunnel drier

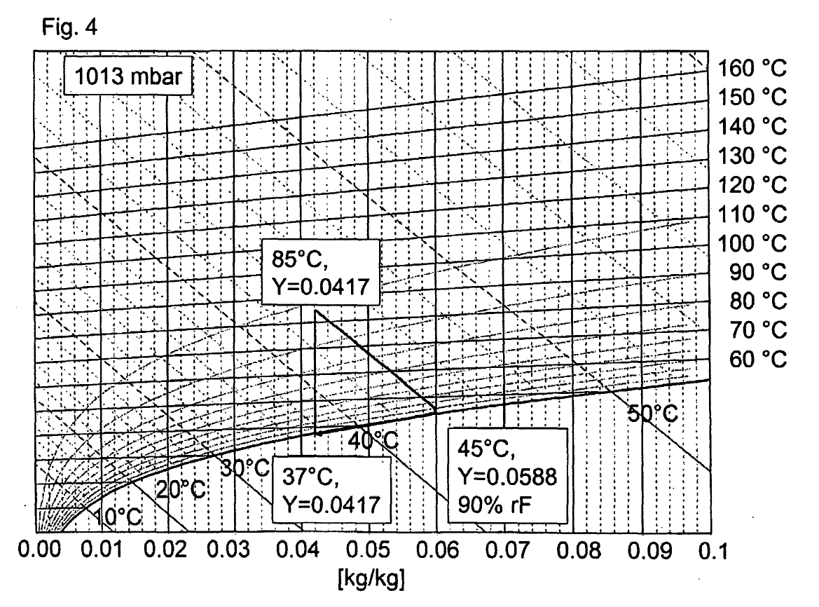

FIG. 4 shows an illustration of the drying profile in a Mollier diagram.

The diagrammatic sequence of the method steps and of the assigned device components may be gathered from FIG. 1. In a first step, the waste consisting of a plastic-rich oversized or coarse fraction of a grain size of between 40 and 300 mm is subjected to hot-air drying 1 in a tunnel drier 10.

It is apparent from FIG. 2 that the supply of the material into the tunnel drier 10 takes place via a shaft supply system 11 by means of traveling and reversible distribution conveyor belts 12, the drying stock 13 at the same time ensuring sealing with respect to the supply system. The tunnel drier is designed as an automatically fillable and emptiable continuous flow tunnel. The dwell time of the drying stock in the tunnel amounts to less then eight hours.

The tunnel drier according to FIGS. 2 and 3 is equipped with an oscillating floor system 14 which allows a mass flow of the drying stock 13 carried through the system. The dumping height in the tunnel drier amounts to between 3 and 6 m, depending on density. The tunnel drier is designed such that the dumping height in the tunnel can be set as a function of the density of the material via a stripper 15.

Discharge from the tunnel drier takes place via a conveyor belt 16, a discharge flap 17 ensuring a metered discharge of the material. Metering allows effective and largely fault-free operation of the further processing assemblies 2, 3, 4, 5 and 6 (cf. FIG. 1).

Circulating air is used as drying air. Circulating air operation is illustrated in FIG. 1. The exhaust air 100 from the tunnel drier 10 is first scrubbed within a spray condenser 110, in this case the circulating air which has a temperature of about 40 to 45° Celsius being cooled to about 35 to 38° Celsius via air cooling 101. The condensate 102 occurring in this case contains harmful substances and, before being discharged into the drainage system, is treated as sewage 105 in the condensate processing 120. Downstream of the spray condenser 110, the circulating air enters the condenser 130. The circulating air is further cooled here via hybrid cooling 103. The condensate 104 occurring in this case is likewise routed for condensate processing 120. The circulating air 106 cooled to less than 30° Celsius is then heated again via a heat exchanger 140 to a drying temperature of 80° Celsius.

Circulating air operation may comprise, in addition to a fan 160, a heat pump 150 which can furnish both part of the cooling power 107 and part of the heating power 108. The heat pump 150 is illustrated by dashes in FIG. 1, since the use of a heat pump may be dispensed with, in so far as there is sufficient waste heat 170 present.

A space-saving arrangement of the aeration technology 18 described above is shown in FIGS. 2 and 3, to be precise on the outside of the tunnel drier 10.

FIG. 4 illustrates the drying profile of the circulating air drying in a Mollier diagram. The heating of the circulating air to 85° Celsius can be seen, as a result of which the relative atmospheric moisture is reduced. The lowering of the circulating air to the cooling limit temperature as a result of drying and condensation and, consequently, the dehumidification of the circulating air as a result of cooling from the cooling limit temperature to 37° Celsius and reheating to 85° Celsius can likewise be seen.

Drying is followed by material flow-specific processing which comprises the steps of screening 2, air separation 3, metal separation 4, optical sorting 5 and comminution 6 of the residual fraction for recirculation into the tunnel drier 10.

Screening 2 is carried out by a screening device 20, the screen being designed in such a way that fine fractions of a grain size <30 mm to 60 mm, preferably <40 mm, are separated. The dry fine stock 21 is suitable for energy utilization.

The air separator 30 serves, above all, for the separation of sheet-like constituents, such as films, paper, paperboard, cardboard boxes and textiles. The separated fly fraction 31 can be utilized either in energy terms or, after further processing, in material terms.

Air separation is followed by metal separation 4. Fe and NE metals 41 are separated from the heavy stock from air separation via the use of a metal separator 40. The dust-free and dry heavy fraction with a grain size of between 40 and 300 mm is thereafter delivered for optical sorting 5. By means of an optical sorter 50, all the optically detectable useful materials, for example PE, PP, PS, PET, PVC, wood, aluminum compounds, etc., are separated. Utilizable product fractions 51 are diverted in a further step.

The remaining, undetected heavy fraction is comminuted 6, 60 to a grain size <40 mm and is returned to the tunnel drier 10.

The overall method therefore consists of the following components:
low-temperature drying of the 40 to 300 mm waste by circulating air;
screening at 30 to 60 mm, preferably 40 mm, wherein subsequent secondary screening of the fine fraction by means of a star screen at 2 to 8 mm may optionally be provided;
air separation of the coarse fraction, which can also take place in two steps;
metal separation from the air-separated heavy fraction;
optical sorting for obtaining useful materials, and
recomminution of the heavy fraction to the target grain size and recirculation into the drier.

1. A method for drying and for the material flow-specific processing of coarse-grained waste that can be aerated wherein, in a first step, the waste is subjected to hot-air drying in a tunnel drier, whereupon this is followed by the further steps of screening for separating the fine stock, preferably with a grain size <40 mm, air separation, metal separation and optical sorting and also comminution of the residual fraction, preferably to a grain size <40 mm, and recirculation of the comminuted residual fraction into the tunnel drier.

2. The method as claimed in claim 1 wherein the hot-air drying takes place essentially in circulating air operation, the supply air being preheated to temperatures of about 85° Celsius.

3. The method as claimed in claim 2 wherein, for exhaust air cooling, a two-step cooling system is used, the first cooling step taking place via air cooling and the second step via hybrid cooling.

4. The method as claimed in claim 2 wherein at least part of the energy for heating and/or cooling the circulating air is provided, using a heat pump.

5. The method as claimed in claim 1 wherein the filling of the tunnel drier takes place via a shaft by means of traveling and reversible distribution conveyor belts, and metering devices are used for the metered material discharge.

6. The method as claimed in claim 1 wherein an oscillating floor system is used for conveying the drying stock through the tunnel drier, and a stripper arranged on the ceiling side is used for setting the dumping height in the tunnel.

7. The method as claimed in claim 1 wherein the dwell time in the tunnel drier amounts to less than eight hours.

8. The method as claimed in claim 1 wherein air separation takes place in two steps.

9. A device for carrying out a method of claim 1, with a tunnel drier for hot-air drying and with a screening device, an air separator, a metal separator and an optical sorting device for processing the dried stock and also with a comminutor for comminuting the residual fraction to be returned to the tunnel drier.

10. The device as claimed in claim 9 wherein the tunnel drier possesses a two-step cooling system consisting of air cooling and of hybrid cooling for cooling the exhaust air.

11. The device as claimed in claim 10 wherein the tunnel drier has, moreover, an oscillating floor system for conveying the drying stock, a stripper, arranged on the ceiling side, for setting the dumping height, and metering devices for a metered material discharge.

12. The device as claimed in claim 9 wherein it possesses a temperature detector, by means of which the introduction of glowing chips into the tunnel drier is avoided.
